(19) United States
(12) Patent Application Publication
(10) Pub. No.: US 2023/0399560 A1
(43) Pub. Date: Dec. 14, 2023

(54) CHEMICAL TREATMENT COMPOSITIONS AND METHODS OF USING THE SAME

(71) Applicant: ChampionX USA Inc., Sugar Land, TX (US)

(72) Inventor: Jeremy MOLONEY, Katy, TX (US)

(73) Assignee: ChampionX USA Inc., Sugar Land, TX (US)

(21) Appl. No.: 18/323,662

(22) Filed: May 25, 2023

Related U.S. Application Data
(60) Provisional application No. 63/350,311, filed on Jun. 8, 2022.

(51) Int. Cl. C09K 8/54

(52) U.S. Cl. CPC C09K 8/54; C09K 2208/32; C09K 2208/22

(57) ABSTRACT

A composition including a powder and a liquid treatment chemical is provided. The powder includes sodium bicarbonate, calcium carbonate, citric acid, oxalic acid, palmitic acid, tartaric acid, and/or maleic acid. The liquid treatment chemical may be an organic sulfur compound, an imidazoline, a carboxylic acid, a fatty acid amine condensate, a substituted fatty acid ester, a substituted aromatic amine, a phosphoric acid ester, a quaternary ammonium compound, a compound having multiple positive charges, and any combination thereof. The composition may be in the form of a tablet. A composition having a liquid treatment chemical disposed within a water-soluble container is also provided.

### TECHNICAL FIELD

The present disclosure generally relates to chemical treatment compositions, products incorporating such compositions, and methods of using the same.

### BACKGROUND

To meet the significant growth in oil and gas demand today, exploration is moving to uncharted, ultra-deep water locations and production is being considered in locations previously considered to be off-limits. Further, much of the existing infrastructure typically operates well beyond its designed capabilities. This overreach creates significant technical challenges in all areas of production; however, no challenge is more difficult than preserving infrastructure integrity.

Corrosion inhibitors are frequently introduced into oil and gas fluids to aid in maintaining infrastructure integrity. Corrosion inhibitors are added to a wide array of systems and system components, such as cooling systems, refinery units, pipelines, steam generators, and oil or gas producing and production water handling equipment. These corrosion inhibitors are geared towards combating a large variety of corrosion types. For example, a common type of corrosion encountered in well bores is acid induced corrosion where the degree of corrosion depends on a multitude of factors. These factors include, for example, the corrosiveness of the fluid, pipeline metallurgy, temperature, time of corrosive fluid contact time, and pressure.

Typically, oilfield corrosion inhibitor products are injected in a liquid form into a production well or pipeline to help mitigate carbon steel assets from corroding. This relies upon there being the required infrastructure such as chemical tanks, skids, pumps, and the like. However, for production facilities and pipelines without such infrastructure the application of usual liquid corrosion inhibitors is more challenging. The primary option available to an operator is either not to treat their facility or to spend significant resources to enable the application of liquid products.

### BRIEF SUMMARY

A composition is provided. The composition includes a powder comprising sodium bicarbonate, calcium carbonate, citric acid, oxalic acid, palmitic acid, tartaric acid, maleic acid, or any combination thereof, and a liquid treatment chemical selected from the group consisting of an organic sulfur compound, an imidazoline, a carboxylic acid, a fatty acid amine condensate, a substituted fatty acid ester, a substituted aromatic amine, a phosphoric acid ester, a quaternary ammonium compound, a compound comprising multiple positive charges, and any combination thereof. The composition may be in the form of a tablet.

In some aspects, the liquid treatment chemical is oil-soluble.

In some aspects, the liquid treatment chemical is selected from the group consisting of 2-mercaptoethanol, a diethylenetriamine (DETA) tall oil fatty acid (TOFA) imidazoline, a reaction product of triethylamine (TEA) and TOFA, a reaction product of TOFA and tetraethylenepentamine (TEPA), an alkyl pyridine, an ethoxylated branched nonylphenol phosphate ester, a benzy-(C₁₂ to C₁₈ linear alkyl)-dimethylammonium chloride, 5-carboxy-4-hexyl-2-cyclohexene octanoic acid, 6-carboxy-4-hexyl-2-cyclohexene octanoic acid, maleated TOFA, an acrylated DETA:TOFA imidazoline, and any combination thereof.

In some aspects, the composition excludes a solvent and/or a wax.

In some aspects, the composition is anhydrous.

In some aspects, the composition comprises from about 40 wt. % to about 99 wt. % of the powder and from about 1 wt. % to about 60 wt. % of the liquid treatment chemical.

In some aspects, a tablet comprises the composition.

In some aspects, the tablet does not include a coating.

In some aspects, the tablet further comprises a coating.

In some aspects, the liquid treatment chemical comprises a hydrate inhibitor, an asphaltene inhibitor, a paraffin inhibitor, a demulsifier, a biocide, a scale inhibitor, a corrosion inhibitor, and any combination thereof.

In other aspects, a composition is provided that includes a liquid treatment chemical selected from the group consisting of an organic sulfur compound, an imidazoline, a carboxylic acid, a fatty acid amine condensate, a substituted fatty acid ester, a substituted aromatic amine, a phosphoric acid ester, a quaternary ammonium compound, a compound comprising multiple positive charges, and any combination thereof. The composition is disposed within a water-soluble container.

In some aspects, the water-soluble container is cellulose-based or comprises gelatin.

In some aspects, the water-soluble container is biodegradable.

In some aspects, the water-soluble container comprises paper, board stock, cardboard, corrugate, or any combination thereof.

In some aspects, the water-soluble container comprises a water dissolvable polymer coating.

In some aspects, the water dissolvable polymer coating comprises a polyvinyl alcohol polymer.

In some aspects, the composition further comprises a water-soluble salt weighting agent.

In some aspects, the weighting agent is sodium chloride, sodium bromide, sodium iodide, calcium chloride, calcium bromide, calcium iodide, or any combination thereof.

In some aspects, the liquid treatment chemical comprises a hydrate inhibitor, an asphaltene inhibitor, a paraffin inhibitor, a demulsifier, a biocide, a scale inhibitor, a corrosion inhibitor, and any combination thereof.

A method of inhibiting corrosion is provided. The method includes adding any composition described herein to a subterranean reservoir.

In some aspects, the composition is added to a wellhead.

An additional method of inhibiting corrosion is provided herein. The method includes adding any composition described herein to a pipeline.

The present disclosure also provides a method of manufacturing a composition. The method includes mixing a liquid treatment chemical with a powder to form a composition, wherein the composition comprises from about 40 wt. % to about 99 wt. % of the powder and from about 1 wt. % to about 60 wt. % of the liquid treatment chemical, and allowing the composition to dry.

Finally, the present disclosure provides a method of transporting a chemical additive. The method includes transporting a composition using a vehicle. The composition includes a powder and a liquid treatment chemical. The powder comprises sodium bicarbonate, calcium carbonate, citric acid, oxalic acid, palm itic acid, tartaric acid, maleic acid, or any combination thereof. The liquid treatment chemical is an organic sulfur compound, an imidazoline, a carboxylic acid, a fatty acid amine condensate, a substituted fatty acid ester, a substituted aromatic amine, a phosphoric acid ester, a quaternary ammonium compound, a compound comprising multiple positive charges, or any combination thereof. The composition is in a form of a tablet or a liquid filled container.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### BRIEF DESCRIPTION OF THE SEVERAL VIEWS OF THE DRAWINGS

A detailed description of the invention is hereafter described with specific reference being made to the drawings in which:

FIG. 1A shows a tablet comprising sodium bicarbonate, citric acid, and 2-mercaptoethanol.

FIG. 1B shows a tablet comprising sodium bicarbonate, citric acid, and Acrylated TOFA:DETA imidazoline.

FIG. 1C shows a tablet comprising sodium bicarbonate, citric acid, and a reaction product of TEA and TOFA.

FIG. 1D shows a tablet comprising sodium bicarbonate, citric acid, and an alkyl pyridine.

FIG. 1E shows a tablet comprising sodium bicarbonate, citric acid, and an ethoxylated branched nonylphenol phosphate ester.

FIG. 1F shows a tablet comprising sodium bicarbonate, citric acid, and a benzyl-(C₁₂-C₁₈ linear alkyl)-dimethyl-ammonium chloride.

FIG. 2 shows a sealed carton/packet in accordance with the present disclosure.

FIGS. 3A-3C show different embodiments of sealed, water-soluble bags containing a treatment chemical.

FIG. 4 shows a gelatin capsule comprising a treatment chemical.

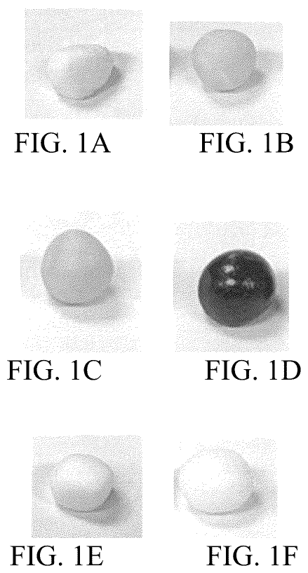

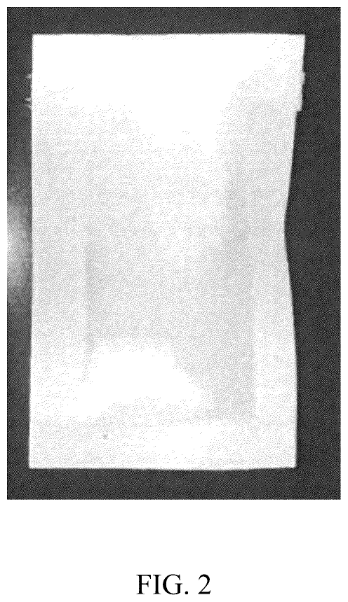

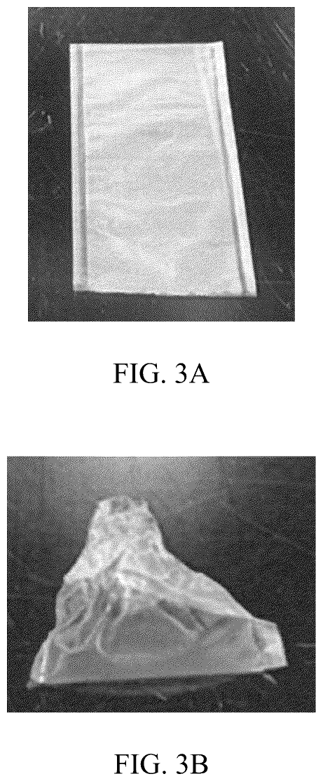

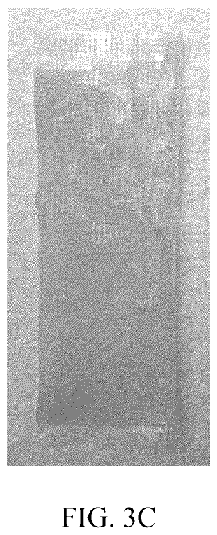

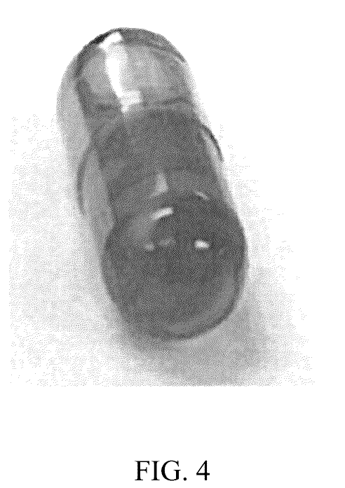

### DETAILED DESCRIPTION

The relationship and functioning of the various elements of the embodiments may better be understood by reference to the following detailed description.

Most oil and gas operations produce varying quantities of hydrocarbon along with water. Typical oilfield active chemistries need to transfer from the hydrocarbon phase to the water phase in which the water-wet carbon steel corrodes. Common oilfield chemistries are surfactant in nature having both hydrophilic and hydrophobic groups and partition to some extent between the water and oil phases. Once on the metal surface, some oil-soluble chemistries can inhibit carbon steel corrosion. However, under low shear, low mixing conditions, there can be insufficient mixing resulting in such molecules residing mainly in the oil, leading to little or no transfer to the water phase and little to no corrosion inhibition under such operating conditions.

The present compositions and methods introduce a novel approach in which liquid corrosion inhibitor chemistry actives are formulated in such a way to not require the infrastructure required for liquid chemical application.

Corrosion inhibitors prepared in solid form, such as a tablet, or as a liquid in a small container enhances the possibility of more oil-soluble chemistries transitioning to the water phase as the table or small container drops through the hydrocarbon layer and into the brine, which in turn increases the likelihood of such chemistries to come into contact with a metal surface and increase corrosion inhibition performance.

In some embodiments, a composition of the present disclosure includes a powder and a liquid treatment chemical.

Examples of powders include, but are not limited to, sodium bicarbonate, calcium carbonate, citric acid, oxalic acid, palm itic acid, tartaric acid, or maleic acid. In some aspects, the powder comprises sodium bicarbonate. In some aspects, the powder comprises calcium carbonate. In some aspects, the powder comprises citric acid. In some aspects, the powder comprises oxalic acid. In some aspects, the powder comprises palmitic acid. In some aspects, the powder comprises tartaric acid. In some aspects, the powder comprises maleic acid. In some aspects, the powder consists essentially of sodium bicarbonate. In some aspects, the powder consists of sodium bicarbonate.

In some aspects, the powder includes a mixture of sodium bicarbonate and citric acid. In some aspects, the powder consists essentially of a mixture of sodium bicarbonate and citric acid. In some aspects, the powder consists of a mixture of sodium bicarbonate and citric acid.

Examples of liquid treatment chemicals include, but are not limited to, an organic sulfur compound, an imidazoline, a carboxylic acid, a fatty acid amine condensate, a substituted fatty acid ester, a substituted aromatic amine, a phosphoric acid ester, a quaternary ammonium compound, or a compound comprising multiple positive charges.

The compound comprising multiple positive charges may be derived from a polyamine through its reactions with an activated olefin and an epoxide, wherein the activated olefin has the following formula:

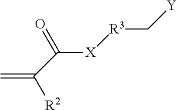

wherein X is NH or O; R² is H, CH₃, or an unsubstituted, linear or branched C₂-C₁₀ alkyl, alkenyl, or alkynyl group; R³ is absent or an unsubstituted, linear C₁-C₃₀ alkylene group; Y is —NR₄R₅R₆⁽⁺⁾; R⁴, R⁵, and R⁶ are independently a C₁-C₁₀ alkyl group; wherein the epoxide has the following formula;

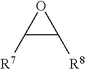

R⁷ is H or alkyl; and R⁸ is alkyl, or —(CH₂)ₖ—O-alkyl, wherein k is an integer of 1-30; wherein the polyamine and activated olefin undergo aza Michael Addition reaction and the polyamine and epoxide undergo ring opening reaction. In some embodiments, the compound comprises a nonionic group.

In some embodiments, the compound has one of the generic formula of NA₂-[R^{10′}]ₙ-NA₂, (RNA)ₙ-RNA₂, NA₂-(RNA)ₙ-RNA₂, or NA₂-(RN(R′))ₙ-RNA₂, wherein R^{10′} is a linear or branched, unsubstituted or substituted C₂-C₁₀ alkylene group, or combination thereof; R is —CH₂—, —CH₂CH₂—, —CH₂CH₂CH₂—, —CH(CH₃)CH₂—, a linear or branched, unsubstituted or substituted C₄-C₁₀ alkylene group, or combination thereof; R′ is —CH₂—, —CH₂CH₂—, —CH₂CH₂CH₂—, —CH(CH₃)CH₂—, a linear or branched, unsubstituted or substituted C₄-C₁₀ alkyl group, RNAB, RNARNAB, or RN(RNAB)₂; n can be from 2 to 1,000,000; A is a combination of H,

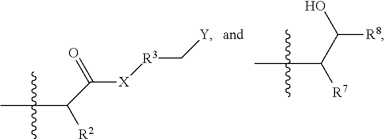

wherein X is NH or O; R² is H, CH₃, or an unsubstituted, linear or branched C₂-C₁₀ alkyl, alkenyl, or alkynyl group; R³ is absent or an unsubstituted, linear C₁-C₃₀ alkylene group; Y is —NR₄R₅R₆⁽⁺⁾; R⁴, R⁵, and R⁶ are independently a C₁-C₁₀ alkyl group; R⁷ is H or alkyl; and R⁸ is alkyl, or —(CH₂)ₖ—O-alkyl, wherein k is an integer of 1-30.

The compound may be a multiple charged cationic compound having a

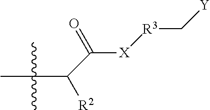

group and a

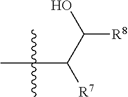

group.

In some aspects, the liquid treatment chemical is oil-soluble.

In some aspects, the liquid treatment chemical can be 2-mercaptoethanol, a DETA:TOFA imidazoline, a reaction product of TEA and TOFA, a reaction product of TOFA and TEPA, an alkyl pyridine, an ethoxylated branched nonylphenol phosphate ester, a benzy-(C₁₂ to C₁₈ linear alkyl)-dimethylammonium chloride, 5-carboxy-4-hexyl-2-cyclohexene octanoic acid, 6-carboxy-4-hexyl-2-cyclohexene octanoic acid, maleated TOFA, an acrylated DETA:TOFA imidazoline, and any combination thereof.

In some aspects, the composition is in the form of a tablet. The tablet can be prepared by combining the powder with the liquid treatment chemical in appropriate ratios to form a mixture. The mixture may then be molded or formed into a tablet.

Referring to compositions in the form of a tablet, the amount of powder in the tablet can be from about 40% by weight to about 99% by weight. In some aspects, the amount of powder in the tablet can be from about 50% by weight to about 95% by weight, from about 70% by weight to about 95% by weight, from about 70% by weight to about 90% by weight, from about 75% by weight to about 90% by weight, or from about 75% by weight to about 85% by weight. In some aspects, the amount of powder in the tablet can be about 80% by weight, about 82% by weight, about 84% by weight, about 86% by weight, about 76% by weight, or about 78% by weight.

Referring to compositions in the form of a tablet, the amount of liquid treatment chemical used to form the tablet can be from about 1% by weight to about 60% by weight. In some aspects, the amount of liquid treatment chemical used to form the tablet can be from about 1% by weight to about 40% by weight, from about 5% by weight to about 35% by weight, from about 5% by weight to about 30% by weight, from about 5% by weight to about 25% by weight, or from about 10% by weight to about 25% by weight. In some aspects, the amount of liquid treatment chemical used to form the tablet can be about 20% by weight, about 18% by weight, about 16% by weight, about 14% by weight, about 24% by weight, or about 22% by weight.

The overall size of the tablet (or puck, pellet, stick, rod, snake, block, marble, or other suitable geometrical shape of the composition) is not particularly limited and may be chosen, for example, based on the intended application of the tablet. In some embodiments, the size may range from about 1 gram to about 1 kg or more if desired. In some embodiments, the size is from about 1 gram to about 10 grams, about 1 gram to about 50 grams, about 1 gram to about 100 grams, about 1 gram to about 300 grams, about 1 gram to about 500 grams, about 1 gram to about 750 grams, about 10 grams to about 1 kg, about 50 grams to about 1 kg, about 100 grams to about 1 kg, about 300 grams to about 1 kg, about 500 grams to about 1 kg, or about 750 grams to about 1 kg.

Additionally, the tablet, puck, pellet, marble, etc., may have a ratio ranging from about 1:10 to about 10:1 (diameter:depth/length), such as from about 1:7, about 1:5, about 1:3, about 1:1, about 3:1, about 5:1, or about 7:1.

In some embodiments, a tablet (or other shape) may have a length, width, and/or depth ranging from about 0.5 inches to about 12 inches or more, such as from about 0.5 inches to about 1 inch, about 0.5 inches to about 2 inches, about 0.5 inches to about 3 inches, about 0.5 inches to about 4 inches, about 0.5 inches to about 5 inches, about 0.5 inches to about 6 inches, about 0.5 inches to about 7 inches, about 0.5 inches to about 8 inches, or about 0.5 inches to about 9 inches.

If a marble, sphere, or other circular shape is selected, the shape may have any desirable diameter, such as from about 0.5 inches to about 12 inches or more, such as from about 1 inch to about 12 inches, about 2 inches to about 12 inches, about 3 inches to about 12 inches, about 4 inches to about 12 inches, about 5 inches to about 12 inches, about 6 inches to about 12 inches, about 7 inches to about 12 inches, about 8 inches to about 12 inches, about 9 inches to about 12 inches, about 10 inches to about 12 inches, or about 11 inches to about 12 inches, for example.

In some aspects, the composition excludes a solvent. In some aspects, the composition excludes a wax.

In some aspects, the composition can be anhydrous.

In some aspects, the tablet optionally includes a coating. The tablet coating can be a water-soluble material, such as gelatin.

In other aspects, a composition is provided that includes a liquid treatment chemical selected from the group consisting of an organic sulfur compound, an imidazoline, a carboxylic acid, a fatty acid amine condensate, a substituted fatty acid ester, a substituted aromatic amine, a phosphoric acid ester, a quaternary ammonium compound, and any combination thereof. The composition is disposed within a water-soluble container.

The water-soluble container can be cellulose-based or comprise gelatin.

In some aspects, the water-soluble container is biodegradable.

The water-soluble container can be constructed from one or more water-dispersible and/or biodegradable compositions. Such water-soluble and biodegradable compositions and/or films can include a first layer having a water-soluble material and a second layer having a biodegradable material. Any suitable number of layers may be chosen and each layer may be independently selected from, for example, a water-soluble layer, an oil-soluble layer, a biodegradable layer, etc. Based on the different numbers of layers and different types of layers, the timing of chemical release may be controlled.

The term “water-soluble,” as used herein, refers to the capability of being at least partially soluble and subsequently partially dispersible (e.g., at least about 70% dispersible) to nearly completely dispersible (e.g., about 100% dispersible) in an aqueous solution, such as water. Contacting the water-soluble container can result in fragmentation of the composition into particulates and/or micro-particulates, where a water-dispersible layer or sheet can form such particulates in an aqueous solution. Water-soluble materials, as referenced herein, include materials and papers referred to in the art as “water-soluble,” where only a portion of the paper may be actually soluble in water, but dissolution of this soluble portion results in dispersion of most or all of the remaining structure.

The term “biodegradable,” as used herein, refers to materials that can be readily decomposed by biological methods, through a combination of heat, moisture, and/or microbial action.

Other suitable materials for the water-soluble container include paper, board stock, cardboard, corrugate, or any combination thereof.

In some aspects, the water-soluble container comprises a water dissolvable polymer coating. The water dissolvable polymer coating can include a polyvinyl alcohol (PVA) polymer.

For liquid compositions disposed within a water-soluble container, such compositions can further include a water-soluble salt weighting agent. Examples of weighting agent include, but are not limited to, sodium chloride, sodium bromide, sodium iodide, calcium chloride, calcium bromide, or calcium iodide. In some aspects, the weighting agent comprises sodium chloride. In some aspects, the weighting agent comprises sodium bromide.

The overall amount of the chemical in the water-soluble container, such as the pod, capsule, box, etc., is not particularly limited and may be chosen, for example, based on the intended application of the tablet. In some embodiments, the amount may range from about 1 ml to about 5 L or more if desired. In some embodiments, the amount is from about 1 ml to about 10 ml, about 1 ml to about 50 ml, about 1 ml to about 100 ml, about 1 ml to about 500 ml, about 1 ml to about 1 L, about 1 ml to about 3 L, about 100 ml to about 5 L, about 500 ml to about 5 L, about 1 L to about 5 L, or about 3 L to about 5 L.

Additionally, the water-soluble container (e.g., the pod, capuslue, box, etc.,) may have a ratio ranging from about 1:10 to about 10:1 (diameter:depth/length), such as from about 1:7, about 1:5, about 1:3, about 1:1, about 3:1, about 5:1, or about 7:1. Various thicknesses are contemplated and, in some embodiments, thickness may be chosen as a factor to determine how quickly a water-soluble container will dissolve. For example, a water-soluble container having a wall thickness from about 1 mm to about 0.5 inches may dissolve faster than a water-soluble container having a wall thickness greater than about 1 inch.

Any composition, container, marble, tablet, etc., disclosed herein may comprise a member selected from the group consisting of a hydrate inhibitor, an asphaltene inhibitor, a paraffin inhibitor, a demulsifier, a biocide, a scale inhibitor, a corrosion inhibitor, and any combination thereof.

A hydrate inhibitor may include, for example, a mono-alkyl amide, a dialkyl amide, an alkyl quaternary ammonium salt, and any combination thereof.

An asphaltene inhibitor may include, for example, an alkylphenol/formaldehyde resin, a polyisobutylene esters, a polyisobutylene imides, a polyalkyl acrylate, and any combination thereof.

A paraffin inhibitor may include, for example, a polyalkyl acrylate, an olefin/maleic anhydride polymer, and any combination thereof.

A demulsifier may include, for example, acrylic acid, a polymer comprising T-butylphenol, an ethylene oxide (EO) polymer, a propylene oxide (PO) polymer, formaldehyde, maleic anhydride, 4-nonylphenol, propenoic acid, a polymer comprising 2,5-furandione, methyloxirane and/or oxirane, and a reaction product of EO, PO, 4-nonylphenol, formaldehyde, maleic anhydride, and acrylic acid.

A biocide may include, for example, glutaraldehyde, tetrakis(hydroxymethyl)phosphonium sulphate, a quaternary ammonium compound, and any combination thereof.

A scale inhibitor may include, for example, a phosphonate, a sulfonate, a phosphate, a phosphate ester, a polymer comprising a phosphonate or phosphonate ester group, a polymeric organic acid, a peroxycarboxylic acid, and any combination thereof. In some embodiments, the scale inhibitor may be selected from a compound comprising an amine and/or a quaternary amine, nitrilotriacetic acid (NTA), ethylenediaminetetraacetic acid (EDTA), diethylenetriamine (DETA) phosphonate, and any combination thereof.

In some embodiments, the scale inhibitor is an acid-based scale inhibitor, such as phosphonic acid. In some embodiments, the scale inhibitor comprises an anionic group. The anionic group may comprise, for example, a carboxylate group or a sulfate group. In some embodiments, the scale inhibitor may include a phosphorous atom, a phosphorous-oxygen double bond, and/or a phosphono group.

In some embodiments, the scale inhibitor is selected from the group consisting of hexamethylene diamine tetrakis (methylene phosphonic acid), diethylene triamine tetra (methylene phosphonic acid), diethylene triamine penta (methylene phosphonic acid), polyacrylic acid (PAA), phosphino carboxylic acid (PPCA), diglycol amine phosphonate (DGA phosphonate), 1-hydroxyethylidene 1,1-diphosphonate (HEDP phosphonate), bisaminoethylether phosphonate (BAEE phosphonate), 2-acrylamido-2-methyl-1-propanesulphonic acid (AMPS), and any combination thereof.

In certain embodiments, the scale inhibitor is a polymer comprising an anionic monomer. The anionic monomer may be selected from, for example, acrylic acid, methacrylic acid, vinyl sulfonic acid, vinyl phosphonic acid, maleic anhydride, itaconic acid, crotonic acid, maleic acid, fumaric acid, styrene sulfonic acid, and any combination thereof.

A method of inhibiting corrosion is also provided in the present disclosure. The method includes adding any composition described herein to a subterranean reservoir. In some aspects, the composition is added to a medium in the subterranean reservoir

In some aspects, the composition is added to a wellhead. In some aspects, the composition is added to a medium in the wellhead.

An additional method of inhibiting corrosion provided by the present disclosure includes a step of adding any composition described herein to a pipeline. In some aspects, the composition is added to a medium in the pipeline.

The present disclosure also provides methods of inhibiting corrosion of a metal surface in contact with a medium. The methods comprise adding an effective amount of a composition to the medium, wherein the composition comprises, consists of, or consists essentially of the reaction product disclosed herein, optionally combined with a solvent. The composition may be added continuously, intermittently, automatically, and/or manually.

In some aspects, the effective amount of the treatment chemical added to the medium is from about 1 ppm to about 10,000 ppm. For example, the effective amount may be from about 1 ppm to about 5,000 ppm, from about 1 ppm to about 4,000 ppm, from about 1 ppm to about 3,000 ppm, from about 1 ppm to about 2,000 ppm, from about 1 ppm to about 1,000 ppm, from about 1 ppm to about 500 ppm, from about 1 ppm to about 250 ppm, or from about 1 ppm to about 100 ppm.

The presently disclosed compositions are useful for inhibiting corrosion of metal surfaces in contact with any type of corrodent in the medium, such as metal cations, metal complexes, metal chelates, organometallic complexes, aluminum ions, ammonium ions, barium ions, chromium ions, cobalt ions, cuprous ions, cupric ions, calcium ions, ferrous ions, ferric ions, hydrogen ions, magnesium ions, manganese ions, molybdenum ions, nickel ions, potassium ions, sodium ions, strontium ions, titanium ions, uranium ions, vanadium ions, zinc ions, bromide ions, carbonate ions, chlorate ions, chloride ions, chlorite ions, dithionate ions, fluoride ions, hypochlorite ions, iodide ions, nitrate ions, nitrite ions, oxide ions, perchlorate ions, peroxide ions, phosphate ions, phosphite ions, sulfate ions, sulfide ions, sulfite ions, hydrogen carbonate ions, hydrogen phosphate ions, hydrogen phosphite ions, hydrogen sulfate ions, hydrogen sulfite ions, an acid, such as carbonic acid, hydrochloric acid, nitric acid, sulfuric acid, nitrous acid, sulfurous acid, a peroxy acid, or phosphoric acid, ammonia, bromine, carbon dioxide, chlorine, chlorine dioxide,fluorine, hydrogen chloride, hydrogen sulfide, iodine, nitrogen dioxide, nitrogen monoxide, oxygen, ozone, sulfur dioxide, hydrogen peroxide, polysaccharides, metal oxides, sands, clays, silicon dioxide, titanium dioxide, muds, insoluble inorganic and/or organic particulates, an oxidizing agent, a chelating agent, an alcohol, and any combination of the foregoing.

The presently disclosed compositions are useful for inhibiting corrosion of surfaces comprising any metal or combination of metals. In some aspects, the metal surface comprises steel, such as stainless steel or carbon steel. In some aspects, the metal surface comprises iron, aluminum, zinc, chromium, manganese, nickel, tungsten, molybdenum, titanium, vanadium, cobalt, niobium, or copper. The metal surface may also comprise any combination of the foregoing metals and/or any one or more of boron, phosphorus, sulfur, silicon, oxygen, and nitrogen. In some aspects, a pipe or a tank (e.g., railroad tank car or a tank truck/tanker) comprises the metal surface.

In some embodiments, the methods disclosed herein further comprise adding a component to the medium. The component may be added before, after, and/or with the composition. The component may be added continuously, automatically, intermittently, and/or manually. In some embodiments, the composition comprises the component. In some embodiments, the composition consists of or consists essentially of the reaction product, a solvent, and a component.

Illustrative, non-limiting examples of components include a fouling control agent, an additional corrosion inhibitor, a corrosion inhibitor intensifier, a biocide, a preservative, an acid, a hydrogen sulfide scavenger, a surfactant, an asphaltene inhibitor, a paraffin inhibitor, a scale inhibitor, a gas hydrate inhibitor, a pH modifier, an emulsion breaker, a reverse emulsion breaker, a coagulant/flocculant agent, an emulsifier, a water clarifier, a dispersant, an antioxidant, a polymer degradation prevention agent, a permeability modifier, a foaming agent, an antifoaming agent, a CO₂ scavenger, an O₂ scavenger, a gelling agent, a lubricant, a friction reducing agent, a salt, a clay stabilizer, a bactericide, a salt substitute, a relative permeability modifier, a breaker, a fluid loss control additive, a chelating agent, a demulsifier, an iron control agent, a drag reducing agent, a flow improver, a viscosity reducer, a solvent, and any combination thereof.

The fouling control agent may comprise, for example, a quaternary compound.

Illustrative, non-limiting examples of biocides include chlorine, hypochlorite, ClO₂, bromine, ozone, hydrogen peroxide, peracetic acid, peroxycarboxylic acid, peroxycarboxylic acid composition, peroxysulphate, glutaraldehyde, dibromonitrilopropionamide, isothiazolone, terbutylazine, polymeric biguanide, methylene bisthiocyanate, tetrakis hydroxymethyl phosphonium sulphate, and any combination thereof.

The acid may comprise, for example, hydrochloric acid, hydrofluoric acid, citric acid, formic acid, acetic acid, or any combination thereof.

The hydrogen sulfide scavenger may comprise, for example, an oxidant, inorganic peroxide, chlorine dioxide, a C₁-C₁₀ aldehyde, formaldehyde, glyoxal, glutaraldehyde, acrolein, methacrolein, a triazine, or any combination thereof.

The compositions and methods disclosed herein may be useful while carrying out various processes in an the oil & gas operation but the compositions and methods may be used in processes from other industries, such as water treatment, geothermal, nuclear, etc.

The present disclosure also provides methods of manufacturing the compositions disclosed herein. A method may include mixing a liquid treatment chemical with a powder to form a composition, wherein the composition comprises from about 40 wt. % to about 99 wt. % of the powder and from about 1 wt. % to about 60 wt. % of the liquid treatment chemical, and allowing the composition to dry.

A method of transporting a chemical additive is also provided by the present disclosure. The method includes transporting a composition using a vehicle, such as a tanker truck or ship. The composition includes a powder and a liquid treatment chemical. The powder comprises sodium bicarbonate, calcium carbonate, citric acid, oxalic acid, palmitic acid, tartaric acid, maleic acid, or any combination thereof. The liquid treatment chemical is an organic sulfur compound, an imidazoline, a carboxylic acid, a fatty acid amine condensate, a substituted fatty acid ester, a substituted aromatic amine, a phosphoric acid ester, a quaternary ammonium compound, or any combination thereof. The composition is in a form of a tablet or a liquid filled container.

### EXAMPLES

Example 1: Tablets

A powder mixture was prepared using about 40 g sodium bicarbonate powder and about 20 g citric acid powder. The powder mixture was mixed with various liquid oilfield active corrosion inhibitor chemistries (see Table 1) at an amount of about 82% by weight powder mixture with about 18% by weight of liquid.

The liquid and powder mixture was formed into ball/marble (i.e., tablet).

TABLE 1
Liquid oilfield active corrosion inhibitor chemistries

| Chemistry | Generic chemistry |
|---|---|
| 2-mercaptoethanol | Organic sulfur compound |
| Acrylated TOFA:DETA imidazoline | Imidazoline |
| Reaction product of TEA and TOFA | Substituted fatty acid ester |
| Alkyl pyridine | Substituted aromatic amine |
| Ethoxylated branched nonylphenol | Phosphoric acid esters |
| phosphate ester | |
| Benzyl-(C12-C18 linear alkyl)- | Quaternary ammonium compounds |
| dimethyl-ammonium chloride | |

Corrosion bubble cell tests were performed using the following conditions to evaluate the corrosion inhibition performance of the corrosion inhibitor tablets on a carbon steel electrode (C₁₀₁₈ grade). The corrosion rate was assessed electrochemically using linear polarization resistance (LPR) methodology. Tests were carried out at atmospheric pressure at about 80° C. using CO₂ saturated fluids with about 3% NaCl brine (about 80%) and LVT-200 hydrocarbon (20%) with a continuous CO2 sparge.

The inhibited corrosion rate at about 15 hours after Cl marble/chemical injection was noted and a percentage inhibition determined by comparing with the corrosion rate of a blank steel electrode at the same time in the test. A relatively low amount of active was purposefully used in order to differentiate between the application approaches.

Table 2 shows the corrosion inhibition results of the various tablets that were prepared.

TABLE 2
Summary of Corrosion inhibition results of liquid
compositions and tablet compositions.

| | | | | Active | | |
|---|---|---|---|---|---|---|
| | | | Compo- | concen- | | |
| | | | sition | tration | Corrosion | |
| | | | Dosage | based | rate | |
| | | | based on | on total | after 15 | % |
| Sample | | Actives | total fluids | fluids | hours | Protec- |
| No. | Chemistry | (%) | (ppm) | (ppm) | (mpv) | tion |
| Blank | None | None | None | None | 441 | None |
| 1 | 2-mercapto- | 18.3 | 1050 | 192 | 41 | 91 |
| | ethanol | | | | | |
| 2 | Acryalted | 14.6 | 1050 | 153 | 63 | 86 |
| | TOFA:DETA | | | | | |
| | imidazoline | | | | | |
| 3 | Reaction | 18.3 | 1050 | 192 | 350 | 21 |
| | product of | | | | | |
| | TEA and | | | | | |
| | TOFA | | | | | |
| 4 | Alkyl | 18.3 | 1050 | 192 | 387 | 12 |
| | pyridine | | | | | |
| 5 | Ethoxylated | 18.3 | 1050 | 192 | 238 | 46 |
| | branched | | | | | |
| | nonylphenol | | | | | |
| | phosphate | | | | | |
| | ester | | | | | |
| 6 | Benzyl- | 18.3 | 1050 | 192 | 182 | 59 |
| | (C12-C18 | | | | | |
| | linear | | | | | |
| | alkyl)- | | | | | |
| | dimethyl- | | | | | |
| | ammonium | | | | | |
| | chloride | | | | | |
| 7 | 2-mercapto- | 18.3 | 1050 | 192 | 16 | 96 |
| | ethanol | | | | | |
| 8 | Acrylated | 14.6 | 1050 | 153 | 3 | 99 |
| | TOFA:DETA | | | | | |
| | imidazoline | | | | | |
| 9 | Reaction | 18.3 | 1050 | 192 | 24 | 95 |
| | product of | | | | | |
| | TEA and | | | | | |
| | TOFA | | | | | |
| 10 | Alkyl | 18.3 | 1050 | 192 | 206 | 53 |
| | pyridine | | | | | |
| 11 | Ethoxylated | 18.3 | 1050 | 192 | 12 | 97 |
| | branched | | | | | |
| | nonylphenol | | | | | |
| | phosphate | | | | | |
| | ester | | | | | |
| 12 | Benzyl- | 18.3 | 1050 | 192 | 4 | 99 |
| | (C12-C18 | | | | | |
| | linear | | | | | |
| | alkyl)- | | | | | |
| | dimethyl- | | | | | |
| | ammonium | | | | | |
| | chloride | | | | | |

### Example 2: Cartons

Cartons containing a liquid corrosion inhibitor were prepared. A water-soluble container was selected, which was cellulose-based and biodegrable (Smartsolve, l×3, 3.5 pt dissolving pouch, 3 side seal). About 20 μL of corrosion inhibitor chemistry material (see chemistries detailed below in Table 3) was added to the container. Also, about 1 g of sodium chloride to act as a weighting agent was added with the corrosion inhibitor chemistry.

Corrosion tests were conducted as described above in Example 1. Table 3 shows the chemistries tested and Table 4 shows the corrosion inhibition results.

TABLE 3
Liquid oilfield active corrosion inhibitor chemistries

| Chemistry | Generic chemistry |
|---|---|
| Reaction product of TEA and TOFA | Substituted fatty acid ester |
| Reaction product of TEA and TEPA | Fatty acid amine condensate |
| Acrylated tall oil fatty acid | imidazoline |
| TOFA:DETA imidazoline | |
| 5(or 6)-carboxy-4-hexyl-2- | Carboxylic acid |
| cyclohexene-octanoic acid | |
| Maleated TOFA | Fatty acid ester |
| Alkyl pyridine | Substituted aromatic amine |
| Reaction product of | Fatty acid amine condensate |
| polyalkylenepolyamine, TOFA, and | |
| linoleic acid dimer with dodecyl | |
| benzene sulfonic acid and linoleic | |
| acid dimer | |

TABLE 4

| | Active Chemistry | | | |
|---|---|---|---|---|
| | Dosage Volume (either | | | |
| | injection of liquid | Amount | | |
| | version or packet/ | of Salt | Corrosion | |
| | carton dropped into | (Sodium | Rate After | |
| | fluids) [based on | Chloride) | 15 h of Cl | % |
| Generic chemistry | total fluids] (ppm) | added (g) | Injection (mpy) | Protection |
| N/A | N/A | N/A | 409 | N/A |
| Liquid versions | | | | |
| Substituted fatty acid aster | 20 | 1 | 425 | −4 |
| Fatty acid amine condensate | 18 | 1 | 444 | −9 |
| Imidazoline | 16 | 1 | 285 | 30 |
| Carboxylic acid | 18 | 1 | 147 | 64 |
| Fatty acid | 20 | 1 | 38 | 91 |
| Substituted aromatic amine | 20 | 1 | 549 | −34 |
| Fatty acid amine condensate | 16 | 1 | 474 | −16 |
| Carton/Packet versions | | | | |
| Substituted fatty acid aster | 20 | 1 | 216 | 47 |
| Fatty acid amine condensate | 18 | 1 | 200 | 51 |
| Imidazoline | 16 | 1 | 7 | 98 |
| Carboxylic acid | 18 | 1 | 14 | 97 |
| Fatty acid | 20 | 1 | 24 | 94 |
| Substituted aromatic amine | 20 | 1 | 65 | 84 |
| Fatty acid amine condensate | 16 | 1 | 237 | 42 |

### Example 3: Water-Dissolvable PVA Pods

The corrosion inhibitor active chemistry (about 20 μL) was added to a water-soluble PVA bag along with sodium chloride (about 1 g) used as a weighting agent. After sealing, the pod was then dropped into the test vessel containing both hydrocarbon and brine along with a carbon steel probe, monitoring the corrosion rate. Corrosion tests were conducted as described above in Example 1. Table 5 shows the chemistries tested and Table 6 shows the corrosion inhibition results.

TABLE 5
Liquid oilfield active corrosion inhibitor chemistries

| Chemistry | Generic chemistry |
|---|---|
| Reaction product of TEA and TOFA | Substituted fatty acid ester |
| Reaction product of TEA and TEPA | Fatty acid amine condensate |
| Acrylated TOFA:DETA imidazoline | imidazoline |
| 5(or 6)-carboxy-4-hexyl-2- | Carboxylic acid |
| cyclohexene-octanoic acid | |
| Maleated TOFA | Fatty acid ester |
| Alkyl pyridine | Substituted aromatic amine |
| Reaction product of | Fatty acid amine condensate |
| polyalkylenepolyamine, TOFA, and | |
| linoleic acid dimer with dodecyl | |
| benzene sulfonic acid and linoleic | |
| acid dimer | |

TABLE 6

| | Active Chemistry | | | |
|---|---|---|---|---|
| | Dosage Volume | | | |
| | (either injection | Amount | | |
| | of liquid version | of Salt | Corrosion | |
| | or pod dropped into | (Sodium | Rate After | |
| | fluids) [based on | Chloride) | 15 h of Cl | % |
| Generic chemistry | total fluids] (ppm) | added (g) | Injection (mpy) | Protection |
| N/A | N/A | N/A | 409 | N/A |
| Liquid versions | | | | |
| Substituted fatty acid aster | 20 | 1 | 425 | −4 |
| Fatty acid amine condensate | 18 | 1 | 444 | −9 |
| Imidazoline | 16 | 1 | 285 | 30 |
| Carboxylic acid | 18 | 1 | 147 | 64 |
| Fatty acid | 20 | 1 | 38 | 91 |
| Substituted aromatic amine | 20 | 1 | 549 | −34 |
| Fatty acid amine condensate | 16 | 1 | 474 | −16 |
| Pod versions | | | | |
| Substituted fatty acid aster | 20 | 1 | 217 | 47 |
| Fatty acid amine condensate | 18 | 1 | 322 | 21 |
| Imidazoline | 16 | 1 | 16 | 96 |
| Carboxylic acid | 18 | 1 | 27 | 93 |
| Fatty acid | 20 | 1 | 15 | 96 |
| Substituted aromatic amine | 20 | 1 | 383 | 6 |
| Fatty acid amine condensate | 16 | 1 | 368 | 10 |

### Example 4: Water-Soluble Gelatin Capsule

The corrosion inhibitor active chemistry (about 20 μL) was added to a Solaray water-soluble gelatin capsule together with sodium bromide (about 1.5 g) as a weighting agent. After sealing, the capsule was then dropped into the test vessel containing both hydrocarbon and brine along with a carbon steel probe, monitoring the corrosion rate. Corrosion tests were conducted as described above in Example 1. Table 7 shows the chemistries tested and Table 8 shows the corrosion inhibition results.

TABLE 7
Liquid oilfield active corrosion inhibitor chemistries

| Chemistry | Generic chemistry |
|---|---|
| Reaction product of TEA and TOFA | Substituted fatty acid ester |
| Reaction product of TEA and TEPA | Fatty acid amine condensate |
| 5(or 6)-carboxy-4-hexyl-2- | Carboxylic acid |
| cyclohexene-octanoic acid | |
| Maleated TOFA | Fatty acid ester |
| Alkyl pyridine | Substituted aromatic amine |
| Reaction product of | Fatty acid amine condensate |
| polyalkylenepolyamine, TOFA, and | |
| linoleic acid dimer with Dodecyl | |
| Benzene Sulfonic Acid and linoleic | |
| acid dimer | |
| Blend of quaternary ammonium | Amine-based corrosion |
| compounds, alkoxylated fatty amine, | inhibitor product |
| substituted aromatic amine, | |
| phosphoric acid esters, 2- | |
| mercaptoethanol | |

TABLE 8

| | Active Chemistry | | | |
|---|---|---|---|---|
| | Dosage Volume | | | |
| | (either injection | Amount | | |
| | of liquid version | of Salt | Corrosion | |
| | or capsule dropped into | (Sodium | Rate After | |
| | fluids) [based on | Bromide) | 15 h of Cl | % |
| Generic chemistry | total fluids] (ppm) | added (g) | Injection (mpy) | Protection |
| N/A | N/A | N/A | 409 | N/A |
| Substituted fatty acid aster | 20 | 1.5 | 513 | −25 |
| Fatty acid amine condensate | 18 | 1.5 | 500 | −22 |
| Carboxylic acid | 18 | 1.5 | 185 | 55 |
| Fatty acid | 20 | 1.5 | 33.2 | 92 |
| Substituted aromatic amine | 20 | 1.5 | 405 | 1 |
| Fatty acid amine condensate | 16 | 1.5 | 433 | −6 |
| Amine based corrosion inhibitor product | 11 | 1.5 | 7.06 | 98 |
| Substituted fatty acid aster | 20 | 1.5 | 146 | 64 |
| Fatty acid amine condensate | 18 | 1.5 | 167 | 59 |
| Carboxylic acid | 18 | 1.5 | 33.8 | 92 |
| Fatty acid | 20 | 1.5 | 9.09 | 98 |
| Substituted aromatic amine | 20 | 1.5 | 162 | 60 |
| Fatty acid amine condensate | 16 | 1.5 | 129 | 68 |
| Amine based corrosion inhibitor product | 11 | 1.5 | 4.4 | 99 |

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a treatment chemical” is intended to include “at least one treatment chemical” or “one or more treatment chemicals.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A composition, comprising:
a powder comprising sodium bicarbonate, calcium carbonate, citric acid, oxalic acid, palmitic acid, tartaric acid, maleic acid, or any combination thereof, and
a liquid treatment chemical selected from the group consisting of an organic sulfur compound, an imidazoline, a carboxylic acid, a fatty acid amine condensate, a substituted fatty acid ester, a substituted aromatic amine, a phosphoric acid ester, a quaternary ammonium compound, a compound comprising multiple positive charges, and any combination thereof;
wherein the composition is in a form of a tablet.

2. The composition of claim 1, wherein the liquid treatment chemical is oil-soluble.

3. The composition of claim 1, wherein the liquid treatment chemical is selected from the group consisting of 2-mercaptoethanol, a diethylenetriamine (DETA) tall oil fatty acid (TOFA) imidazoline, a reaction product of triethylamine (TEA) and TOFA, a reaction product of TOFA and tetraethylenepentamine (TEPA), an alkyl pyridine, an ethoxylated branched nonylphenol phosphate ester, a benzy-(C₁₂ to C₁₈ linear alkyl)-dimethylammonium chloride, 5-carboxy-4-hexyl-2-cyclohexene octanoic acid, 6-carboxy-4-hexyl-2-cyclohexene octanoic acid, maleated TOFA, an acrylated DETA:TOFA imidazoline, and any combination thereof.

4. The composition of claim 1, wherein the composition excludes a solvent and/or a wax.

5. The composition of claim 1, wherein the composition is anhydrous.

6. The composition of claim 1, wherein the composition comprises from about 40 wt. % to about 99 wt. % of the powder and from about 1 wt. % to about 60 wt. % of the liquid treatment chemical.

7. The composition of claim 1, wherein the composition is a tablet.

8. The composition of claim 7, wherein the tablet does not include a coating.

9. The composition of claim 1, wherein the liquid treatment chemical comprises a hydrate inhibitor, an asphaltene inhibitor, a paraffin inhibitor, a demulsifier, a biocide, a scale inhibitor, a corrosion inhibitor, and any combination thereof.

10. A composition, comprising:
a liquid treatment chemical selected from the group consisting of an organic sulfur compound, an imidazoline, a carboxylic acid, a fatty acid amine condensate, a substituted fatty acid ester, a substituted aromatic amine, a phosphoric acid ester, a quaternary ammonium compound, a compound comprising multiple positive charges, and any combination thereof;
wherein the composition is disposed within a water-soluble container.

11. The composition of claim 10, wherein the water-soluble container is cellulose-based or comprises gelatin.

12. The composition of claim 10, wherein the water-soluble container is biodegradable.

13. The composition of claim 10, wherein the water-soluble container comprises paper, board stock, cardboard, corrugate, or any combination thereof.

14. The composition of claim 10, wherein the water-soluble container comprises a water dissolvable polymer coating.

15. The composition of claim 14, wherein the water dissolvable polymer coating comprises a polyvinyl alcohol polymer.

16. The composition of claim 10, wherein the composition further comprises a water-soluble salt weighting agent.

17. The composition of claim 16, wherein the weighting agent is sodium chloride, sodium bromide, sodium iodide, calcium chloride, calcium bromide, calcium iodide, or any combination thereof.

18. The composition of claim 10, wherein the liquid treatment chemical comprises a hydrate inhibitor, an asphaltene inhibitor, a paraffin inhibitor, a demulsifier, a biocide, a scale inhibitor, a corrosion inhibitor, and any combination thereof.

19. A method of inhibiting corrosion of a metallic surface, comprising:
adding the composition of claim 1 to a medium in a subterranean reservoir, wellhead, and/or pipeline, wherein the medium comprises the metallic surface.
